(19) United States
(12) Patent Application Publication
(10) Pub. No.: US 2022/0110268 A1
(43) Pub. Date: Apr. 14, 2022

(54) EFFECTIVE AND BENEFICIAL VESSELS AND METHOD FOR GROWING PLANTS TO MANIPULATE ROOT GROWTH

(71) Applicant: TOV-CHAI CHVILY, TEL-AVIV (IL)

(72) Inventor: TOV-CHAI CHVILY, TEL-AVIV (IL)

(21) Appl. No.: 17/497,938

(22) Filed: Oct. 10, 2021

(30) Foreign Application Priority Data
Oct. 13, 2020 (IL) 278002

(51) Int. Cl. A01G 9/02; A47G 7/04

(52) U.S. Cl. CPC A01G 9/021; A47G 7/045

(57) ABSTRACT

The invention provides flexible or rigid vessels in different configurations with openings at their ends and a hollow body between them for growing plants. The hollow body is filled with a growing medium to manipulate the routing of the plants roots. Such vessels allow growth of plants in a limited space without compromising the ability of the plants to grow roots of natural length; enabling resource savings by reducing amounts of the growing medium and nutrients and their dispersion to the surrounding, evaporation and water infiltration. These advantages result in a reduction of weight of the growing medium for growing roots. These vessels also protect the plant roots from pests and weeds and allow the plants to grow even in unsuitable terrain, such as rocky, salty or contaminated soil. Also, the vessels can be used to grow plants for ornamental purposes in a beautiful and aesthetic way.

### TECHNICAL FIELD

The present invention pertains to flexible or rigid plant vessels. In particular, the present invention pertains to generally hollow vessels that are made of flexible or rigid materials and shaped to occupy minimal space and maintain maximal volume for growth of plant roots, be adaptable to different positions and optimize growth of plants for domestic or agricultural purposes.

### BACKGROUND

When growing plants traditionally, in soil or containers there is a need for suitable space and extensive use of resources such as growing medium, nutrients and water. Among the various methods exists today for growing plants are the use of open ground, water-filled containers (in hydroponic agriculture), greenhouses and growing on shelves or perforated tubes and multipurpose tanks of various shapes and sizes. All the above suffer from several disadvantages compared to the present invention—They require the use of a wide space or container adjusted to the roots of the plant and the use of a lot of growing medium for the purpose of filling this space or container, which also leads to increased use of nutrients and increased use of resources due to evaporation and water infiltration.

US 2015/0342130A1 describes a limited method for spiral routing, only in helix shape sunk into a flowerpot and rising from the bottom of the flowerpot upwards the rim of the flowerpot. Contrary to the foregoing, the proposed invention deals with independent units which substitute a planter or a pot and are not necessarily hidden. In contrast to the mentioned invention, the amount of growing medium required in the present invention is the amount of growing medium required to fill the tube only, which makes it lightweight for use on roofs. The uniqueness of the proposed invention is its ability to be hung, placed on a surface, and attached to bars. In addition, it has added aesthetic value especially in a transparent tube, especially in hydroponic growth. It should be noted that today there are many methods for routing stems and plant branches, mainly for ornamental purposes.

WO 2014/175619 describes a flower arrangement tube for beautifying a surrounding environment. The wall of the tube is perforated on and along with a plurality of holes with at predetermined intervals between them, and into which different types of plant or flower decorations, natural or artificial, may be inserted. The volume of the tube can be filled with fillers such as polystyrene foam or floral foam. Otherwise, a support tube can be inserted into the flower arrangement tube to support the flowers without fillers. The tube itself can be flexible and freely bent.

U.S. Pat. No. 9,125,349 describes a self-contained gardening system that utilizes a continuous tubular structure raised on stringer supports that provide a spiral configuration. The tubular section comprises ports that allow planting along its length. The system also comprises a porous hose within to water the plants and provide them with nutrients. Port covers may be provided to inhibit rain, insects, pests, diseases and outer undesirables from gaining access to the soil and plant roots.

US 2016/249522 describes a seed tape with seeds embedded at a spacing distance from one another in a tubular sleeve. The sleeve is a textile tube, which encloses the seeds in a stretched manner before or during germination and is unstretched between the seed positions. The seeds are embedded in at least one substrate or are in contact with such substrate. This planting system may also comprise a tubular or pipe-like irrigation system with a coating, which can be made of a waterproof synthetic material and having pores, from which irrigation liquid can exit.

The walls of all the plant growth tubes in these publications are necessarily perforated to enable the planting and growing of plants along them. The planting at their end exits is not even considered, because the objective is to plant vertically along the tubes walls. Using these tubes for planting only at their exits will require sealing the holes in the tubes walls. This is actually suggested in these publications, but with covers that are removable, and which do not form a solid and continuous layer or sheet with the walls of the tube. This causes a problem when attempting to convert these tubes and their use to a tube in which the plants grow only in the tubes end exits. None of these publications teaches, describes or suggests a plant growth tube or vessel that is made of a single, solid and continuous sheet without any perforations or holes along its walls, where such tube or vessel enables to grow plants at its end exits, hold any filling within its volume, prevent evaporation of water to the surroundings and infiltration of pests and infections through the walls and be oriented essentially at any angle relative to the ground without spilling off of its filling as long as its end exits face up.

It is, therefore, an object of the present invention to deal with the routing of plant roots for the purpose of achieving excessive efficiency of resources.

It is yet another object of the present invention to provide hollow vessels for growing plants, where such vessels are made of flexible or rigid materials and can be shaped in different forms to adapt to hanging or placing of the plants and occupying minimal space.

This and other objects and embodiments of the invention will become apparent as the description proceeds.

### SUMMARY

This present invention provides aesthetic, cost-effective hollow vessels for accommodating and growing plants. Such vessels use the same principle with agricultural and domestic applications that allows rooting the shape of the root in a spiral or convoluted manner and thereby to achieve a significant reduction in the plant's requirements for soil depth, growing medium, fertilizers and water, since these substances remain concentrated in the cavity of the hollow vessels for the sole use of the plant and do not disperse. Further, this principle as applied to the hollow vessels of the present invention allows more plants to grow on the same space, because of their elasticity that enables to fold them to occupy less space and place several of them in a defined volume.

In one embodiment, the present invention provides a vessel for cultivating plants, where such vessel comprises

a hollow body; and

openings at opposite ends of said body, where the body is made of a flexible or rigid material that enables to shape the vessel in configurations so that the aerial distance between the open ends of the body is smaller than the total length of the body, and where the body is filled with a growing medium for growing said plants. The wall of the vessel is a single solid sheet that is continuous along length of the vessel and between the opposite ends of the vessel. The wall is designed or manufactured to manipulate routing roots of the plants within the volume of the vessel, along the length of the vessel and from one end to opposite end of the vessel.

In one aspect, the present invention uses a simple geometric principle as mentioned above for a variety of hollow vessels for routing plant roots by planting in a hollow body, which outlines the shape of the roots. These vessels can be filled with a growth medium that is most suitable for the growth of the particular plant and with the right amount and density for it. Such growth medium may be selected from soil, silicate beads, porous gravel, tuff, pebble stones, water, hydroponic substrate and any other substrate that enables growth of roots, absorption of nutrients and pest control.

The vessels are hollow bodies that can be made from a variety of materials—breathable, non-breathable, transparent, opaque, hard, porous or spongy. The bodies can be shaped in a variety of shapes and sizes, among them spiral and curvy wave shapes. In one particular embodiment, the number of bends or twists is determined according to the expected length of the plant roots. The twists or bends, as the case may be, have a relatively moderate slope that allows the plant roots to grow optimally, while directing them to the required shape.

In one particular embodiment, depending on the specific design, the body may have one or more openings. The diameter of the openings can be equal to or different from each other or from the diameter of the body and may create a cone like shape for more convenient irrigation and cultivation. If required, the ends of the body can be shaped perpendicular or parallel to the direction of the windings.

In still another embodiment, drainage of excess water and ventilation of the roots can be done with the use of porous materials or creation of dedicated perforations or holes in the body. In still another particular embodiment, the walls of the body enable ventilation of the growth medium inside the body and/or expel of water and or evaporation of water. Such fluid communication between the growth medium and the surroundings of the vessel allows controlling the levels of humidity and air inside the growth medium by expelling excessive water and exchanging and refreshing air. Further, the design of the vessels creates a relatively large surface to volume ratio due to their twisted design. Such ratio reduces the exposure of the growth medium in the body to the surroundings and as a result generates a significant decrease in escape of humidity out of the growth medium. This in turn keeps the humidity inside the medium in the body and saves watering costs.

The vessels can be buried in the ground. Also they can be hung or laid down horizontally or vertically in such a way that the length or depth required to populate roots of a certain length is dramatically reduced. Therefore, when growing on floors or shelves the required distances between unit to unit are significantly smaller than those between regular pots.

In one embodiment, the vessels of the present invention can also be used as a decorative accessory by hanging on walls, fences, vertical surfaces such as building walls, windows or balcony bars, especially in their transparent version that allows viewing the roots in hydroponic growth. Particularly, the vessels can even be used as pots themselves.

In one particular embodiment, rigid vessels of the present invention are made of materials selected from clay, ceramics, porcelain, glass, concrete, polyester, plaster, canvas or utah fabric, metals or metallic materials and combinations thereof. Such rigid vessels are designed in advance to guide the roots of a plant to grow in certain direction in a medium that fills their volume. Further, such vessels can be in fluid communication with the surroundings with holes made in their walls to allow proper ventilation and/or water evaporation off of the growth medium to the surroundings.

Alternatively, the walls of such rigid vessels may block unidirectional or bidirectional flow of air and/or water and/or water vapor between the growth medium inside the vessels and their surroundings.

In still another particular embodiment, the vessels of the present invention are suitable for threading on and hanging off of elevated cables. Particularly, the cables may carry a plurality of hanging vessels, where the cables stretch between vertically positioned poles or pillars, which are positioned parallel each other. Still in another particular embodiment, the cables may be stretched between such poles or pillars in a single or a plurality of heights above ground, and the vessels may hang down in corresponding single or plurality of levels.

The following details some advantages of the hollow, flexible or rigid vessels of the present invention:
1. They allows saving use of fertilizers and water for irrigation due to the compact volume of the vessels and minimal filling of the growing medium.
2. The vessels of the present invention allow the growth of relatively large plants on the roofs of houses and buildings while significantly reducing the load on the roof
3. The vessels can be buried in the ground or laid on it, which allows cultivation in an area where the soil is contaminated or rocky or such that is not suitable for growing plants due to physical or chemical compositions, e.g., salty soil, without the need to clean the soil, cover with an additional layer of soil or replace it. In particular, these vessels enable to grow plants in physically or chemically contaminated terrain by providing a closed nutritious environment for the plants and plant roots to grow inside them.
4. The vessels allow for easier collection of commercially valuable substances, such as fertilizers, nutrients and minerals, released by roots into the growing medium by reducing the volume of the growing medium and preventing the dispersal of the desired substances.
5. By enclosing developing roots according to the method of the present invention, the shape of the roots may be closely controlled which may be of advantage (optimization or standardization of size, shape, etc.) if the roots are themselves a commercial product (e.g. radishes or carrots).
6. The vessels of the present invention improve the ability to prevent weed growth, and the ability to avoid the root system of neighboring plants thus achieving a reduction in competition for necessary resources.
7. The vessels of the present invention enable to control the moisture level of the soil and thus allow the prevention of the development of harmful pathogens that thrive at certain levels of humidity.
8. The vessels of the present invention enable the protection of the roots from pests. Further, use of pesticides, which may be introduced into the soil, is reduced significantly due to the confined space that the vessel encloses and does not allow their distribution or decomposition in the surrounding land. Such confined space also limits the infiltration of pests into the soil and thus the damage that they might cause the plant.
9. The devices can be re-used or manufactured from recycled or environmentally friendly materials.

In what follows and in accordance with the previous paragraphs, a detailed description of preferred non-limiting embodiments of the invention is disclosed for the hollow vessels for growing plants without departing from the scope and spirit of the invention.

### BRIEF DESCRIPTION OF THE DRAWINGS

FIG. 1 illustrates a particular configuration of a hollow vessel of the present invention.

FIG. 2 illustrates another particular configuration of a hollow vessel of the present invention.

FIG. 3 illustrates a third particular configuration of a hollow vessel of the present invention.

FIG. 4- illustrates a fourth particular configuration of a hollow vessel of the present invention.

FIG. 5 illustrates a fifth particular configuration of a hollow vessel of the present invention.

FIG. 6 illustrates a particular application of the vessels of the present invention.

### DETAILED DESCRIPTION OF THE DRAWINGS

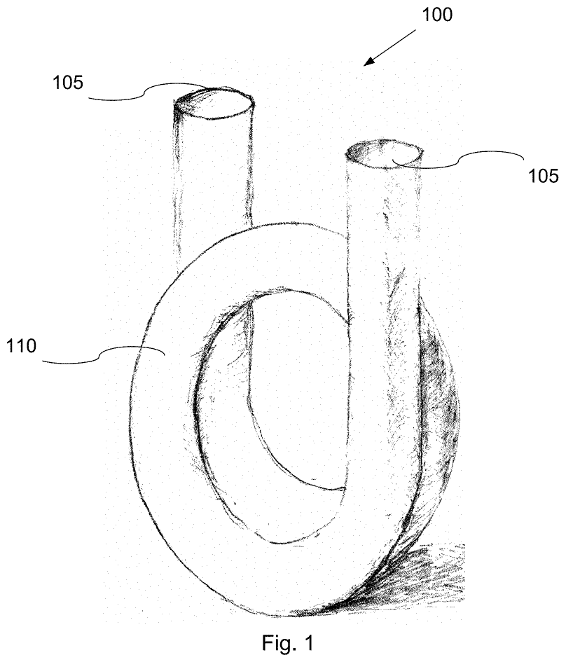

FIG. 1 illustrates a spirally shaped hollow vessel 100 with two openings 105. The body 110 can be manufactured from transparent or opaque materials. It can be made of hydrophobic materials to prevent evaporation of humidity off of the soil or naturally or mechanically perforated to enable proper ventilation as required for cultivating plants. Alternatively, the body 110 can be made of materials with characteristics in the range between opacity and transparency and hydrophobic and perforated qualities adapted to the needs of the specific plants, which are grown in them. The vessel can be used as a stand-alone body laid on the ground or buried in the ground with only its openings exposed to the air. The twist of the body 110 also illustrates the twisted path, which the roots of the plants are forced to grow along its course. FIG. 1 essentially exemplifies the flexibility of the vessels of the present invention that allows to design them in any configuration which is suitable to any specific plant, objective of growth to be achieved and available conditions of space and accommodation.

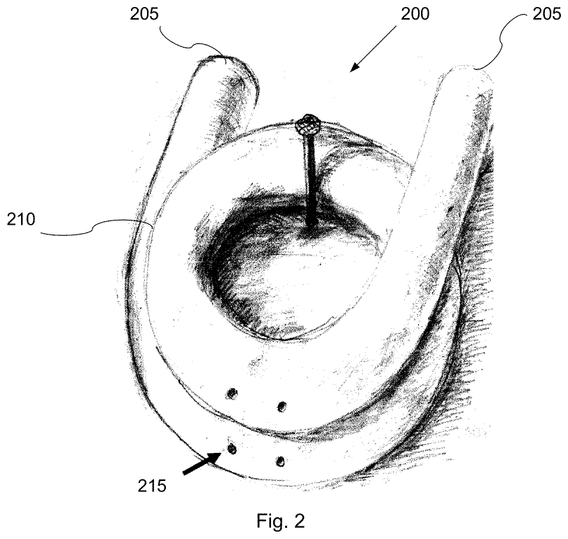

FIG. 2 illustrates another configuration 200 of the vessels of the present invention, namely a spirally shaped hollow body 210 having two openings 205. This vessel can also be manufactured from transparent or opaque, humidity resistant or perforated materials, for cultivating plants. The vessel 200 can be used as a stand-alone body for hanging. FIG. 2 also illustrates drainage and ventilation holes 215 for reaching a balance with the surroundings in humidity and air concentrations. These holes 215 are only exemplary of the location and number of holes that can be mechanically punched in the body 210. Alternatively, the material of the body may be a woven or non-woven fabric, made from natural or synthetic materials or any combination thereof, with a selected density of warp and weaving fibers or threads. Such materials may be selected from wool, cotton, bamboo fiber, Cordura (nylon, nylon mixed with cotton or other natural fibers), PE (Polyethylene), PP (Polypropylene), HDPE (High Density PE), MDPE (Medium-density polyethylene), LLDPE (Linear Low Density PE),and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PS (Polystyrene), Nylon 6,6, and Nylon 6 and combination thereof.

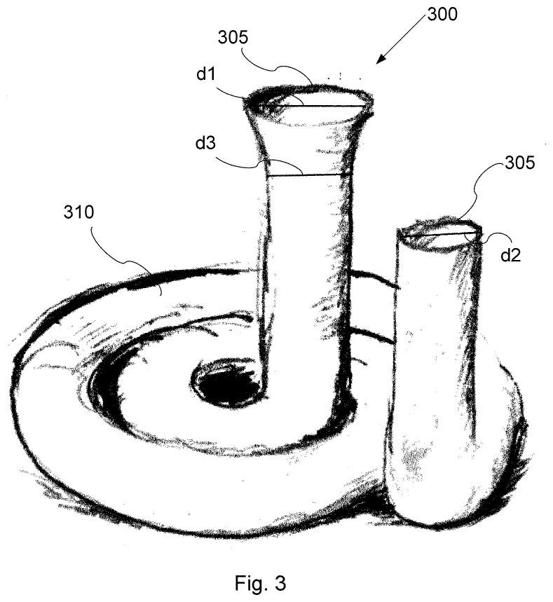

FIG. 3 illustrates a third spirally shaped vessel 300 with a hollow body 310 with one or more openings 305, which can be manufactured from transparent or opaque, humidity resistant or perforated materials, for cultivating plants. The vessel can be used as a stand-alone body laid on the ground or buried in the ground. FIG. 3 also shows that the openings 305 diameters may be different from each other. FIG. 3 also exemplifies possible configurations of the openings. One particular example is the difference in diameters of the two openings, d1 and d2, where d1 is bigger than d2.

Another particular example is the cone shape of the upper part of the body that gradually expands towards the opening. This can be seen in the difference between the smaller diameter, d3, of the lower base of the cone and the bigger diameter, d1, of the opening, which is the upper base of the cone.

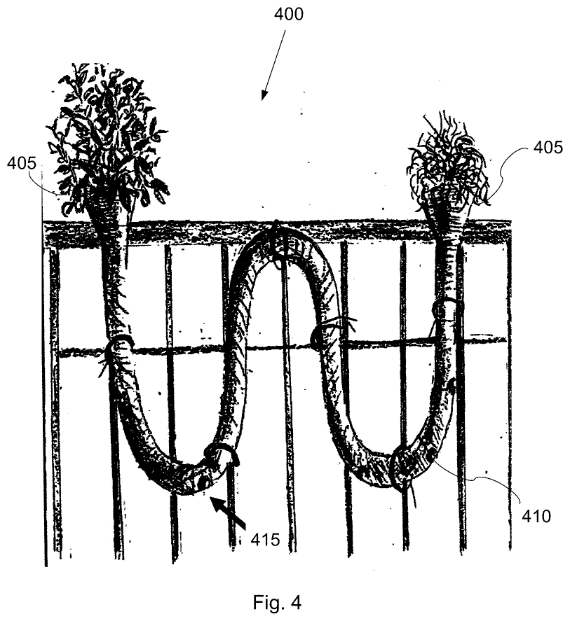

FIG. 4 illustrates a fourth configuration of a vessel 400 with a hollow body 410, which is shaped as a curvy wave with one or more openings 405. This configuration of the vessel can be manufactured from transparent or opaque, humidity resistant or perforated materials, for cultivating plants. This vessel 400 is adapted for attachment to fences, railings, window bars and the like. Drainage and ventilation holes 415 may be punched at selected locations at the lower parts of the wavy body.

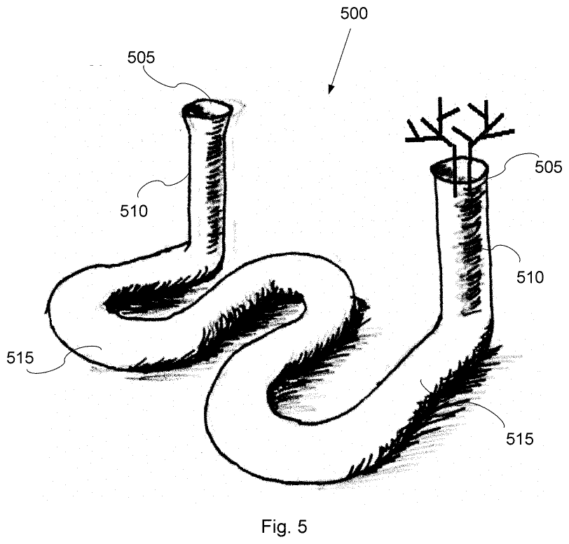

FIG. 5 illustrates a fifth configuration of a vessel 500 of the present invention. The body 515 of the vessel is hollow and shaped as a curvy wave with one or more openings 505 that can be manufactured from transparent or opaque, humidity resistant or perforated materials, for cultivating plants. The perpendicular position of the vertical part 510 of the body relative its horizontal part 515 enables to lay the vessel 500 on the ground or horizontal surface as a stand-alone body with the horizontal part 515 of the body used as a solid base and its vertical part 510 rises upwards and is supported by the horizontal part. Alternatively, the vessel 500 can buried in the ground, where the horizontal part of the body supports its vertical parts with only the openings exposed to the surrounding air.

It should be noted that the different configurations illustrated in FIGS. 1-5 can be made of any one of the materials and combinations thereof as detailed above and used in various positions, which are illustrated in any other Figure or different ones that may be suitable for their use. Further, the flexibility of the vessels of the present invention enables to shape them in many other configurations for use in different modes of attachment to supporting objects, non-supported positions on the ground and hanging and underground positions.

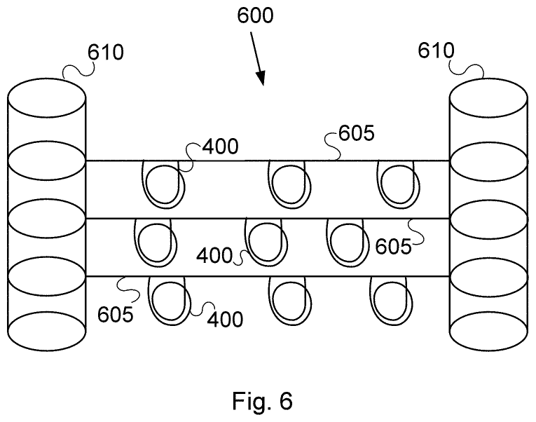

FIG. 6 schematically illustrates a construction 600 for hanging vessels of the design 400 of the present invention and forming a type of a vertical surface for growing plants. In this particular example, the construction comprises vertically oriented poles 610 positioned parallel each other and one or more cables 605 horizontally stretched between these poles. The vessels are attached to the cables by any means of attachment which is sufficient to carry their load and evenly distribute it throughout the entire construction as the plants grow. The desired result may be live fence, wall and any other vertical surface which are formed by plants that may eventually cover the entire construction and the vessels themselves. This basic idea may be applied to other constructions with more complex designs and shapes for creating lively, possibly colorful, plant covered artistic structures, sculptures and monuments for useful and/or decorative purposes.

It should be noted that the hollow shape of the vessels of the present invention is only exemplary to the various shapes that such vessels can have. In other non-limiting particular embodiments of the present invention, the vessels can be rectangular, hexagonal or octagonal. These and other shapes are contemplated within the scope of the present invention as long as their flexibility enables to shape them in compact configurations, which are the same or similar to the configurations as illustrated in the present invention. Further, such shapes of vessels may be made of similar or same materials as detailed above and have similar or same characteristics such as ventilation, perforation and hydrophilic or hydrophobic qualities.

1. A vessel for cultivating plants comprising:
a hollow body; and
openings at opposite ends of said body,
wherein said body is made of a flexible or rigid material that enables to shape said vessel in configurations so that the aerial distance between the open ends of the body is smaller than the total length of the body,
wherein said body is filled with a growing medium for growing said plants, and
wherein wall of said vessel is a single solid sheet that is continuous along length of said vessel and between said opposite ends of said vessel, said wall is designed or manufactured to manipulate routing roots of said plants within volume of said vessel, along length of said vessel and from one end to opposite end of said vessel.

2. The vessel according to claim 1, wherein said vessel is made of a woven or non-woven fabric, said fabric is made from natural or synthetic materials or any combination thereof.

3. The vessel according to claim 2, wherein said fabric is woven and made of a selected density of warp and weaving fibers or threads.

4. The vessel according to claims 2, wherein said fabric is made of materials selected from wool, cotton, bamboo fiber, Cordura (nylon, nylon mixed with cotton or other natural fibers), PE (Polyethylene), PP (Polypropylene), HDPE (High Density PE), MDPE (Medium-density polyethylene), LLDPE (Linear Low Density PE),and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PS (Polystyrene), Nylon 6,6, and Nylon 6 and combination thereof.

5. The vessel according to claim 2, wherein said materials provide said vessel with characteristics selected from ventilation, perforation, hydrophilic and hydrophobic qualities.

6. The vessel according to claim 1, wherein said vessel is made of materials selected from clay, ceramics, porcelain, glass, concrete, polyester, plaster, canvas, utah fabric, metals or metallic materials and combinations thereof.

7. The vessel according to claim 1, wherein said vessel is configured to be laid on the ground, wherein said body fixes position of said vessel so that openings of said vessel face upwards.

8. The vessel according to claim 1, wherein said vessel is configured to be buried underground, wherein said openings protrude out of upper surface of said ground.

9. The vessel according to claim 1, wherein said vessel is configured to be hung above ground, wherein said openings face upwards.

10. The vessel according to claim 9, wherein a plurality of said vessel hung down from horizontally stretched cables between vertically oriented poles that are positioned parallel each other.

11. The vessel according to claim 9, wherein a plurality of said vessels hung down from cables stretched over vertical surfaces, artistic structures, sculptures and monuments for useful and/or decorative purposes.

12. The vessel according to claim 1, wherein said vessel is configured to be filled with a growth medium and designed to direct roots of said plants by forcing said roots to grow in a certain shape inside volume of said medium.

13. The vessel according to claim 12, wherein said vessel is configured to isolate said plants from surroundings of said vessel and enable growth of said plants in a rocky, salty or chemically or physically contaminated terrain.

14. The vessel according to claim 12, wherein said growth medium is selected from soil, silicate beans, porous gravel, tuff, pebble stones, water, hydroponic substrate and any other substrate that enables growth of roots, absorption of nutrients and pest control.

15. The vessel according to claim 1, wherein said vessel facilitates containing substances of economic value inside said body and preventing said substances from being secreted from roots of said plants and disposed off to surroundings of said vessel.

16. The vessel according to claim 1, wherein said vessel is configured to isolate roots of said plants from pests or weeds.

17. The vessel according to claim 1, wherein shape of said vessel is selected from cylindrical, rectangular, hexagonal and octagonal.

18. The vessel according to claim 1, wherein said vessel is adapted for attachment to fences, railings and window bars, vertical surfaces, walls, artistic structures, sculptures and monuments for useful and/or decorative purposes.

19. The vessel according claim 1, wherein said body comprises holes punched at selected location of said body.

20. The vessel according to claim 19, wherein shape of said body is a curvy wave and wherein said holes are punched at lower parts of said body.

21. The vessel according to claim 1, wherein diameter of one opening is bigger than diameter of a second opening.

22. The vessel according to claim 1, wherein one or more openings are cone-shaped, wherein diameter of upper base is bigger than diameter of lower base of said openings.
